(19) United States
(12) Patent Application Publication
(10) Pub. No.: US 2006/0159869 A1
(43) Pub. Date: Jul. 20, 2006

(54) Reactive materials systems and methods for solid freeform fabrication of three-dimensional objects

(76) Inventors: Laura Kramer, Corvallis, OR (US); Christopher Oriakhi, Corvallis, OR (US); Isaac Farr, Corvallis, OR (US); Terry M. Lambright, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/035,824

(22) Filed: Jan. 14, 2005

(51) Int. Cl. B44F 7/00

(52) U.S. Cl. 428/15

(57) ABSTRACT

Systems and methods which utilize a plurality of reactive build compositions differing from one another in at least one material property and which may be applied, individually and/or in combination, layer upon layer to form solid three-dimensional objects having regions which vary in the at least one material property are provided. Further provided are systems and methods which utilize a plurality of reactive build compositions differing from one another in at least one material property and which may be applied, individually and/or in combination, layer upon layer to form a plurality of three-dimensional objects in a single solid freeform fabrication build, at least one object of the plurality of objects having a material property which differs from the same material property of at least one other object fabricated in the same build. Further provided are three-dimensional objects formed utilizing the disclosed systems and methods.

### FIELD OF THE INVENTION

The present invention relates to the production of solid three-dimensional objects. More specifically, the present invention relates to the use of a plurality of reactive build compositions which differ from one another in at least one material property and which may be applied, individually and/or in combination, layer upon layer to form three-dimensional objects having regions which vary in the at least one material property.

### BACKGROUND OF THE INVENTION

Solid freeform fabrication (SFF), also known as rapid prototyping, is a designation for a group of fabrication technologies that produce three-dimensional objects using additive formation steps without the use of part-specific tooling (e.g., molds or dies). The three-dimensional object is commonly produced initially from a three-dimensional representation devised using Computer Aided Design (CAD). The three-dimensional representation is then imported into another compatible piece of software that provides a layer-by-layer slicing of the object into consecutive two-dimensional layers which may be fabricated and accrued to produce the three-dimensional object. SFF has been used to create prototypes in a variety of industries, including the automotive, aerospace, medical, dental, and biomedical prostheses manufacturing fields. Exemplary fabrication technologies encompassed by the designation include stereolithography, selective laser sintering, laminated object manufacturing, fused deposition modeling, and thermal phase change and photopolymer phase change inkjet technologies.

Current SFF technologies permit the fabrication of objects within a single SFF build utilizing only a single build material. Consequently, whether a single object or multiple objects are fabricated in a single build, only objects having a single set of material properties may be produced from the build. While some technologies have the capability to be used with a variety of build materials, only a single material may be used with each build and, thus, the materials cannot be varied within a single object and all objects within a single build must be fabricated from only one material. As a result, if the desired object includes regions with varying material properties, e.g., a flexible region and a rigid region, each region must be separately fabricated from a different build material and subsequently assembled. Similarly, if a build permits the fabrication of multiple objects simultaneously but two or more desired objects have varying material properties, each of the two or more objects must be separately fabricated.

Further, current SFF technologies permit fabrication using only a limited set of build materials. Thus, objects having only a limited set of material properties may be produced utilizing these technologies.

### BRIEF SUMMARY OF THE INVENTION

The present invention provides a method for freeform fabrication of a solid three-dimensional object. The method includes providing a first reactive build composition which includes a material property defined by a first attribute, and providing a second reactive build composition which includes the same material property defined by a second attribute, the first and second attributes differing from one another. For instance, the first reactive build composition may be mechanically flexible and the second reactive build composition may be mechanically rigid. The method further comprises dispensing the first and second reactive build compositions onto a substrate to form a mixed composition and curing the mixed composition to form a layer of cured composition. The cured composition may include the material property of the first and second reactive build compositions defined by a third attribute which differs from each of the first and second attributes and which is dependent upon the respective amounts of the first and second reactive build compositions dispensed. For example, if a relatively large amount of the first (mechanically flexible) reactive build composition is dispensed and a relatively small amount of the second (mechanically rigid) reactive build composition is dispensed to form the mixed composition, the layer of cured composition will have a mechanical property that is somewhat flexible, though not as flexible as the first reactive build composition nor as rigid as the second reactive build composition. The method may further comprise accruing a plurality of layers of cured composition successively bound to one another to form the three-dimensional object.

The present invention further provides a system for freeform fabrication of a solid three-dimensional object comprising a dispensing system and a curing system. The dispensing system may be configured to separately contain a first reactive build composition having a material property defined by a first attribute and a second reactive build composition having the same material property defined by a second attribute, the first and second attributes being different from one another. For instance, the first reactive build composition may be mechanically flexible and the second reactive build composition may be mechanically rigid. The dispensing system may be further configured to independently dispense the first and second reactive build compositions onto a substrate to form a mixed composition. The curing system may be operative to cure the mixed composition to form a layer of cured composition. The cured composition may include the material property of the first and second reactive build compositions defined by a third attribute, which differs from each of the first and second attributes and which is dependent upon the respective amounts of the first and second reactive build compositions dispensed. For example, if a relatively large amount of the first (mechanically flexible) reactive build composition is dispensed and a relatively small amount of the second (mechanically rigid) reactive build composition is dispensed to form the layer of cured composition, the cured composition will have a mechanical property that is somewhat flexible, though not as flexible as the first reactive build composition nor as rigid as the second reactive build composition. The system may further comprise a computer control system that can control the dispensing system and the curing system.

Still further, the present invention provides a solid three-dimensional object formed by a freeform fabrication process which comprises a plurality of layers of a cured composition successively bound to one another. Each layer of the plurality of layers may be formed by curing a mixed composition comprising a first reactive build composition having a material property defined by a first attribute and a second reactive build composition having the same material property defined by a second attribute. After curing, the mixed composition may include the material property defined by a third attribute, which differs from each of the first and second attributes and is dependent upon the respective amounts of the first and second reactive build compositions.

Other features and advantages of the present invention will become apparent to those of ordinary skill in the art through consideration of the ensuing description, the accompanying drawings and the appended claims.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following description of the invention when read in conjunction with the accompanying drawings in which:

FIG. 1 is a block diagram of a representative solid freeform fabrication (SFF) system according to the present invention;

FIGS. 2A-2C are a schematic illustration of a method for freeform fabrication of a solid three-dimensional object in accordance with an embodiment of the present invention, wherein separate inkjet print cartridges are utilized for containing and dispensing each of a first and a second reactive build composition, and wherein the first and second reactive build compositions are dispensed such that they are interspersed with one another;

FIG. 3 illustrates an embodiment of an inkjet print cartridge having a first compartment for containing a first reactive build composition and a second compartment for containing a second reactive build composition which may be used with the SFF systems of the present invention;

FIGS. 4A-4C are schematic illustrations of a method for freeform fabrication of a solid three-dimensional object in accordance with an embodiment of the present invention wherein separate inkjet print cartridges are utilized for containing and dispensing each of a first and a second reactive build composition and wherein the second reactive build composition is dispensed over the first reactive build composition;

FIG. 5A is a schematic illustration of a method for freeform fabrication of a solid three-dimensional object in accordance with an embodiment of the present invention wherein separate inkjet print cartridges are utilized for containing and dispensing each of a first reactive build composition, a second reactive build composition, and a curing composition, and wherein the each of the first reactive build composition, the second reactive build composition, and the curing composition are interspersed with one another;

FIG. 5B is a schematic illustration of a method for freeform fabrication of a solid three-dimensional object in accordance with an embodiment of the present invention wherein separate inkjet print cartridges are utilized for containing and dispensing each of a first reactive build composition, a second reactive build composition, and a curing composition, and wherein the second reactive build composition is dispensed over the first reactive build composition and the curing composition is dispensed over the second reactive build composition; and

FIG. 6 illustrates an exemplary solid three-dimensional object fabricated according to the SFF systems and methods of the present invention, the solid three-dimensional object having two distinct regions which vary in at least one material property.

### DETAILED DESCRIPTION OF THE INVENTION

The present invention is directed to the production of solid three-dimensional objects. More specifically, the present invention is directed to systems and methods which utilize a plurality of reactive build compositions which differ from one another in at least one material property and which may be applied, individually and/or in combination, layer upon layer to form three-dimensional objects having regions which vary in the at least one material property. Further, the present invention is directed to the use of a plurality of reactive build compositions which differ from one another in at least one material property and which may be applied, individually and/or in combination, layer upon layer to form a plurality of three-dimensional objects in a single solid freeform fabrication build, at least one object of the plurality of objects having a material property which differs from the same material property of at least one other object fabricated in the same build. Still further, the present invention is directed to solid three-dimensional objects formed utilizing the disclosed systems and methods. The particular embodiments described herein are intended in all respects to be illustrative rather than restrictive. Other and further embodiments will become apparent to those of ordinary skill in the art to which the present invention pertains without departing from its scope.

The present invention describes the use of at least a first reactive build composition and a second reactive build composition to fabricate a solid three-dimensional object having at least one material property which varies between different regions thereof or among multiple objects fabricated from the same SFF build. As used herein, the term “reactive build composition” refers to a composition having one or more reactive groups capable of reacting with an appropriate curing mechanism to form a cured composition. The term “solid three-dimensional object,” “three-dimensional object,” or “object” refers to objects that are formed by the SFF technology of the present invention. Solid three-dimensional objects are typically sufficiently rigid to maintain a fixed volume and shape to an extent which is appropriate for use in three-dimensional modeling (e.g., exhibiting substantially no perceptible flow at room temperature). It will be understood and appreciated by those of ordinary skill in the art that the term may include states of the three-dimensional object before and after the object has completely cured. In this regard, when dispensing a layer of composition upon a previously cured layer, the previously cured layer is typically not fully cured to provide good adhesion with the subsequently applied layer.

The reactive build compositions of the present invention may be dispensed and cured layer upon layer onto a substrate to fabricate a three-dimensional object one cross-section at a time. As used herein, the term “substrate” may include a build platform, a removable material supported by a build platform, and/or a previously dispensed and cured compositional layer, depending on the context (e.g., the stage of processing).

Varying amounts of each reactive build composition may be dispensed, as more fully described below, to fabricate a solid three-dimensional object having at least one material property which differs between at least two regions thereof. That is, the amount of each reactive build composition dispensed may be tailored depending on the desired material properties for the region of the three-dimensional object being fabricated. For instance, a first reactive build composition may be mechanically flexible and a second reactive build composition may be mechanically rigid. If, in fabricating a region of the desired three-dimensional object, a relatively large amount of the first (mechanically flexible) reactive build composition is dispensed and a relatively small amount of the second (mechanically rigid) reactive build composition is dispensed, a region of the object may be fabricated which is somewhat flexible, though not as flexible as a region fabricated using only the first reactive build composition nor as rigid as a region fabricated using only the second reactive build composition.

Each layer of mixed composition (i.e., a composition comprising from about 0 to 100 parts of the first reactive build composition and from about 0 to 100 parts of the second reactive build composition) may be exposed to a suitable curing system so that subsequently dispensed layers of mixed composition may be cured and accrued to define the three-dimensional object. As used herein, the term “curing” refers to the reactive process that occurs after exposure of the reactive build compositions of the present invention to a suitable curing system, e.g., ultra-violet light or contact with a curing composition. It will be understood by those of ordinary skill in the art that a state of cure would include reactive build compositions of the present invention that are in various states of partial cure. Curing may occur from the precise moment of exposure of the reactive build compositions to the curing system. The term “curing,” “cure,” or the like, is not intended to imply that the resulting composition is necessarily a hard substance in the traditional sense. For example, the reactive build compositions of the present invention may be cured to form a three-dimensional object having one or more flexible regions.

Using the systems and methods of the present invention, objects may be fabricated in a single SFF build which include multiple regions that vary with respect to one another in at least one material property. As used herein, the term “material property” refers to, for instance, one or more of the mechanical, optical, or conductive properties of the reactive build compositions of the present invention. It will be understood and appreciated by those of ordinary skill in the art that “regions” of an object may include a single layer of the three-dimensional object being fabricated as well as a region defined by another dimension such that one or more material properties may vary within a single layer of the solid three-dimensional object.

Further, the systems and methods of the present invention permit the fabrication of multiple objects within a single SFF build, each object having at least one region having at least one material property which differs from the same material property of at least one region of at least one other object fabricated in the same build.

Still further, the systems and methods of the present invention permit the freeform fabrication of objects with materials having a substantial range of material properties. For instance, if a first reactive build composition which is mechanically flexible and a second reactive build composition which is mechanically rigid are utilized, a three-dimensional object may be fabricated which includes a mechanical property defined by an attribute falling anywhere within the range between the flexible first reactive build composition and the rigid second reactive build composition, the mechanical property of any given region being dependent on the respective amounts of the first and second reactive build compositions present in that region. Each of the first and second reactive build compositions may be dispensed, in the fabrication of each region of the solid three-dimensional object, in an amount ranging from about 0 to 100 parts of the total mixed composition, depending on the material properties desired.

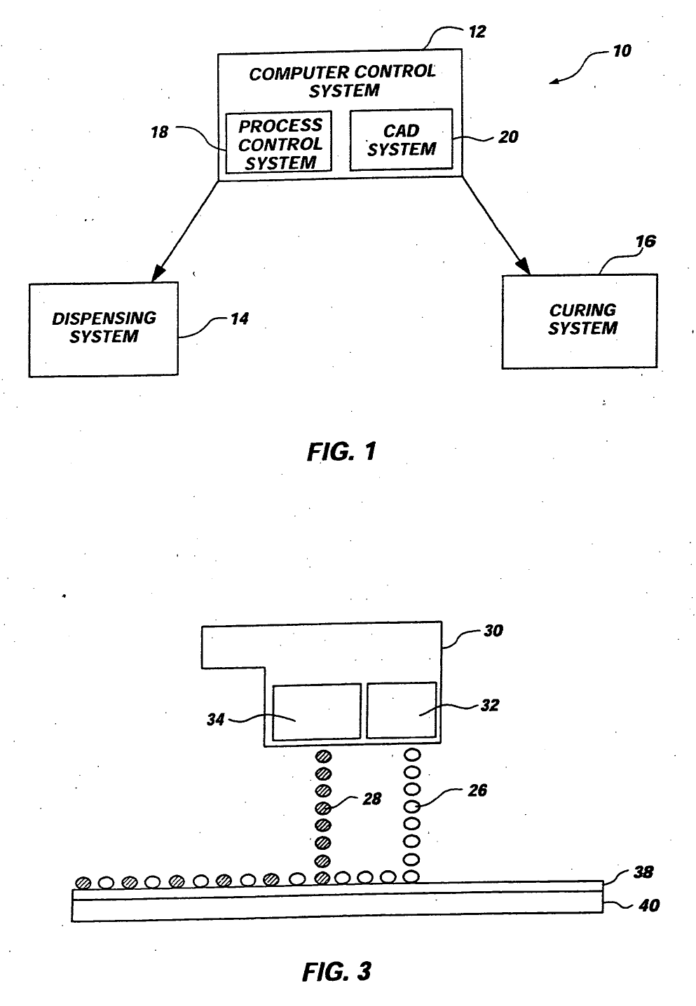

Referring now to the drawings in general, and initially to FIG. 1 in particular, a solid freeform fabrication (SFF) system in accordance with the present invention is illustrated and designated generally as reference numeral 10. The SFF system includes a computer control system 12, a dispensing system 14 and a curing system 16. It will be understood and appreciated by those of ordinary skill in the art that the curing system 16 may be any known conventional curing system including, but not limited to, an ultraviolet or visible radiation curing system or a chemical curing system, which is operative to cure the reactive build compositions dispensed from the dispensing system 14, as more fully described below. The curing system 16 may be selected based upon the chemistry of the reactive materials system utilized.

The computer control system 12 includes a process control system 18 that may be configured to control both the dispensing system 14 and the curing system 16. If desired, the process control system 18 may also be configured to control other related systems including, but not limited to, a positioning system (not shown) and a build platform temperature control system (not shown). Additionally, the computer control system 12 may include, by way of example only, a Computer Aided Design (CAD) system 20 or other SSF CAD-related system.

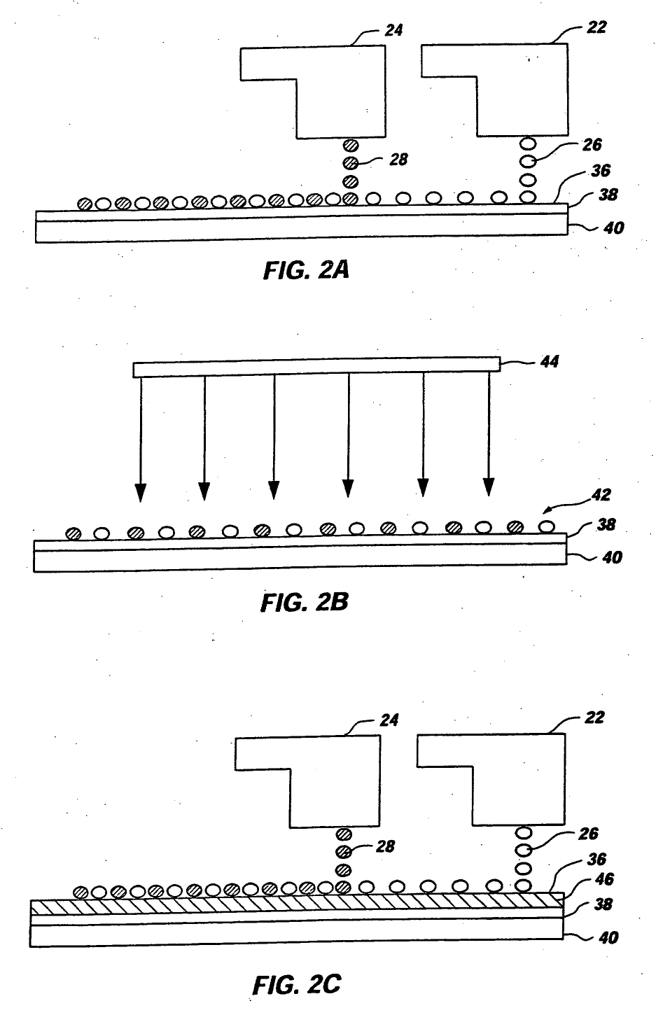

The dispensing system 14 may include, but is not limited to, conventional inkjet technologies, such as drop-on-demand and continuous flow inkjet technologies, that may be used to dispense one or more chemical compositions (e.g., reactive build compositions and/or curing compositions), as more fully described below. The dispensing system 14 may include at least one conventional inkjet print cartridge (e.g., a thermal inkjet print cartridge, a continuous inkjet print cartridge, an electrostatic inkjet print cartridge and/or a piezo inkjet print cartridge) configured to dispense one or more of the chemical compositions through one or more of a plurality of inkjet print cartridge dispensers. For instance, in one embodiment, the dispensing system may include a single inkjet print cartridge for containing and dispensing each of a plurality of reactive build compositions and, where applicable, one or more curing compositions. This embodiment is shown in FIGS. 2A-2C, 4A-4C, 5A and 5B. In another embodiment, a single inkjet print cartridge may include a plurality of inkjet compartments, e.g., tanks or wells, which are configured to independently contain one or more reactive build compositions of the present invention and/or one or more curing compositions, each inkjet compartment being operatively coupled to an independent inkjet dispenser. This embodiment is shown in FIG. 3. The inkjet compartments and/or dispensers may be heated, if desired, to assist in dispensing viscous chemical compositions.

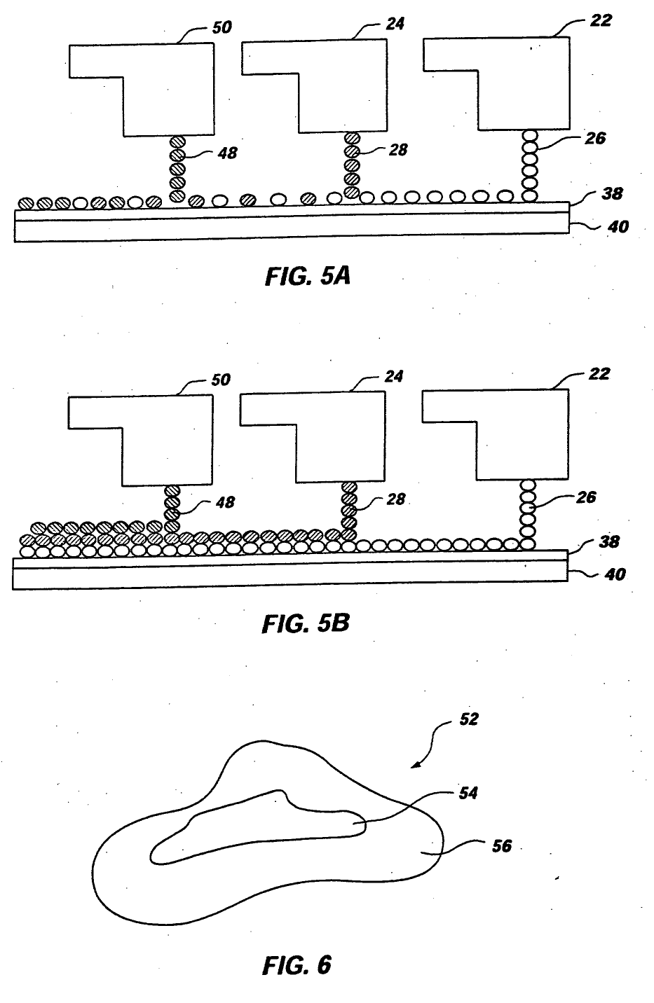

Referring now to FIGS. 2A-2C, a method for freeform fabrication of one or more solid three-dimensional objects utilizing the system of the present invention is illustrated. In the illustrated embodiment, the dispensing system 14 (FIG. 1) includes a first inkjet print cartridge 22 having a first reactive build composition 26 contained therein and a second inkjet print cartridge 24 having a second reactive build composition 28 contained therein. While the illustrated embodiment shows only two inkjet print cartridges 22, 24, it will be understood by those of ordinary skill in the art that any number of inkjet print cartridges 22, 24 may be utilized with the methods of the present invention depending upon the number of chemical compositions (e.g., reactive build compositions 26, 28 and/or curing compositions 48 (FIGS. 5A and 5B)) desired. The first reactive build composition 26 may be prepared to include at least one material property (e.g., a mechanical, optical, or conductive property) defined by a first attribute and the second reactive build composition 28 may be prepared to include the same material property defined by a second attribute, the first and second attributes differing from one another. By way of example, and not limitation, the first reactive build composition 26 may have may have a mechanical property which is relatively flexible while the second reactive build composition 28 may have a mechanical property which is relatively rigid.

In another embodiment, the dispensing system 14 (FIG. 1) may include a single inkjet print cartridge 30 having a plurality of inkjet compartments 32, 34, e.g., tanks or wells, which are configured to independently contain the reactive build compositions 26, 28 and/or curing compositions 48 (FIGS. 5A and 5B) of the present invention, each inkjet compartment 32, 34 being operatively coupled to an independent inkjet dispenser. This embodiment is shown in FIG. 3. In the embodiment of FIG. 3, the inkjet print cartridge 30 comprises two inkjet compartments 32, 34, one for containing and dispensing each of the first reactive build composition 26 and the second reactive build composition 28. It will, however, be understood and appreciated by those of ordinary skill in the art that a single inkjet print cartridge 30 may comprise any desired number of inkjet compartments 32, 34 depending upon the number of chemical compositions (e.g., reactive build compositions 26, 28 and/or curing compositions 48 (FIGS. 5A and 5B)) desired. It will be further understood that any combination of inkjet print cartridges with any number of inkjet compartments may be utilized. For instance, a single inkjet print cartridge 30 having a plurality of inkjet compartments 32, 34, one for containing and dispensing each of a plurality of reactive build compositions 26, 28, may be used in conjunction with a single inkjet print cartridge 22, 24, or 50 (FIGS. 5A and 5B) for containing and dispensing a single curing composition 48 (FIGS. 5A and 5B). All such variations are contemplated to be within the scope hereof.

If desired, one or both of the first and second reactive build compositions 26, 28 may include a liquid vehicle added thereto. A liquid vehicle may, for instance, alter the viscosity, surface tension, or the like of one or both of the first and second reactive build compositions 26, 28. Alternatively, one or both of the first and second reactive build compositions 26, 28 may be an essentially pure composition void of a liquid vehicle. In either case, the first and second reactive build compositions 26, 28 are configured to be dispensed from inkjet dispensers of the first and second inkjet print cartridges 22, 24 (FIG. 2A) and/or single inkjet print cartridge 30 (FIG. 3), as more fully described below.

As used herein, “liquid vehicle” refers to a liquid that may be prepared to be dispensed, in combination with the reactive build compositions 26, 28 and/or curing compositions 48 (FIGS. 5A and 5B) of the present invention, from an inkjet print cartridge 22, 24, 30, or 50 (FIGS. 5A and 5B) to, for example, modify the viscosity, surface tension, or the like of the reactive build compositions 26, 28 and/or curing compositions 48 (FIGS. 5A and 5B). If desired, the liquid vehicle may also include one or more colorants. A wide variety of liquid vehicles may be used with the systems and methods of the present invention. For instance, suitable liquid vehicles may include a mixture of a variety of different agents including, but not limited to, water, surfactants, organic solvents and co-solvents, buffers, biocides, sequestering agents, viscosity modifiers, soluble low molecular weight monomers, oligomers, and polymers. Liquid vehicles may also be configured to include other materials, such as, for example, latex particulates or particulate polymers, as known to those of ordinary skill in the art.

Referring back to FIG. 2A, in fabricating a solid three-dimensional object according to the methods of the present invention, the first and second reactive build compositions 26, 28 may be dispensed onto a substrate 36. In the illustrated embodiment, the substrate 36 is provided by a removable material 38 supported by a build platform 40. The build platform 40 may be any conventional platform known to those of ordinary skill in the art and is typically a rigid platform that can be used to support the solid three-dimensional object as it is formed. The removable material 38 is optional and may, if desired, be utilized to separate the solid three-dimensional object, once formed, from the build platform 40. The removable material 38 may be wax, a water-swellable gel, a readily meltable material, a readily soluble material, or another material that can carry the solid three-dimensional object being built, as well as be configured to be readily removed. The removable material 38 may be applied by an inkjet print cartridge or other deposition technique, as known to those of ordinary skill in the art, and may be used not only to separate the solid three-dimensional object from the build platform 40, but also may be applied to support overhanging features of the solid three-dimensional object.

In the embodiment illustrated in FIG. 2A, the first and second reactive build compositions 26, 28 are dispensed such that they are interspersed with one another to form a mixed composition 42. That is, gaps in coverage provided by the first composition 26 remain open to be filled by the second composition 28 such that an alternating checkerboard pattern results. Each of the first and second reactive build compositions 26, 28 may be dispensed, in the fabrication of each layer of the solid three-dimensional object, in an amount ranging from about 0 to 100 parts of the mixed composition, depending on the material properties desired. Thus, if a larger volume of one of the first and second reactive build compositions 26, 28 is dispensed, a true checkerboard pattern may not result. It will be understood and appreciated by those of ordinary skill in the art that the volume of one or both of the first and second reactive build compositions 26, 28 dispensed may vary not only between layers of the solid three-dimensional object but also within a single layer.

The mixed composition 42 may subsequently be exposed to a suitable curing system 16 (FIG. 1), e.g., a source of ultraviolet radiation 44 as shown in FIG. 2B, to initiate curing thereof. Once curing is initiated, the mixed composition 42 becomes a layer of cured composition 46 (FIG. 2C).

A plurality of layers of cured composition 46 may subsequently be accrued, one upon another, to form a solid three-dimensional object 52 (FIG. 6). Once at least one layer of cured composition 46 has been fabricated, the layer of cured composition 46 may comprise the substrate 36 for a subsequently fabricated layer. When dispensing a layer of composition upon a substrate 36 comprising a previously cured compositional layer 46, the previously cured layer is typically not fully cured to provide good adhesion with the subsequently applied layer.

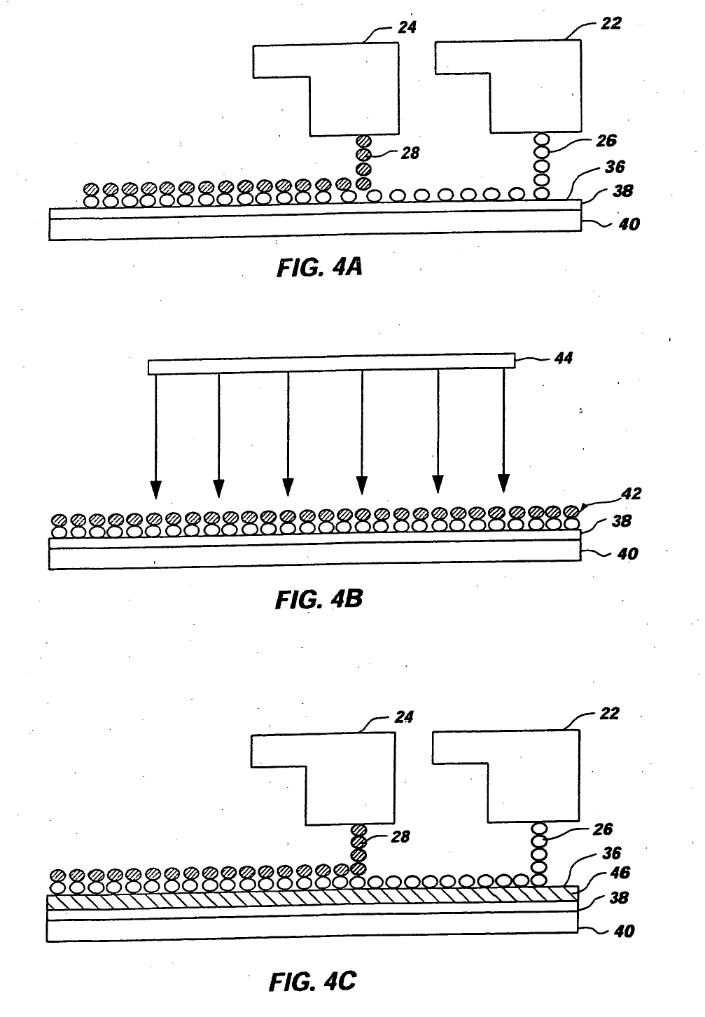

Though in the embodiment illustrated in FIGS. 2A-2C and 3, the first and second reactive build compositions 26, 28 are dispensed such that they are interspersed with one another to form the mixed composition 42, it will be understood and appreciated by those of ordinary skill in the art that other methods may be utilized within the scope of the present invention. For instance, one of the first and second reactive build compositions 26, 28 may be dispensed under the other such that, upon initiation of cure, a single layer of cured composition 46 is fabricated. This embodiment is illustrated in FIGS. 4A-4C. Alternatively, the first and second reactive build compositions 26, 28 may be mixed “in flight” between the respective inkjet dispensers of the one or more inkjet print cartridges 22, 24, or 30 and the substrate 36. These and other alternatives will be apparent to those of ordinary skill in the art.

Further, in the embodiment of FIGS. 2A-2C, the curing system 16 (FIG. 1) is shown as a source of ultraviolet radiation 44. However, it will be understood and appreciated by those of ordinary skill in the art that other suitable curing systems 16 (FIG. 1) may be utilized as well. By way of example, and not limitation, FIGS. 5A and 5B illustrate a chemical curing system 16 (FIG. 1) wherein a curing composition 48 may be dispensed from a separate inkjet print cartridge 50 and added to the first and second reactive build compositions 26, 28 to form the mixed composition 42. A “curing composition” includes any composition that is capable of reacting with the first and second reactive build compositions 26, 28 to form a layer of cured composition 46. Curing compositions 48 may also include a liquid vehicle admixed therewith, though this is not required, as long as the curing composition 48 has desirable dispensability properties. In the embodiment of FIG. 5A, the curing composition 48 is illustrated as being interspersed with the first and second reactive build compositions 26, 28 to form the mixed composition 42. In the embodiment of FIG. 5B, the curing composition 48 is illustrated as being dispersed over the first and second reactive build compositions 26, 28. These and other variations, e.g., mixing the reactive build compositions 26, 28 and curing composition 48 “in flight,” are contemplated to be within the scope hereof.

Additionally, as previously discussed, the curing composition 48 may be contained in an individual inkjet compartment 32, 34 of a single inkjet print cartridge 30, such as the inkjet print cartridge shown in FIG. 3. When utilizing a chemical curing system 16 (FIG. 1), the first and second reactive build compositions 26, 28 will typically provide the bulk of the mixed composition 42, as they are generally applied in a greater volume than the curing composition 48.

Regardless of the curing system 16 (FIG. 1) utilized, the first and second reactive build compositions 26, 28 of the present invention may be prepared to at least partially cure in a relatively short period of time ranging, for example, from a few seconds to a couple of minutes. The first and second reactive build compositions 26, 28 also may be prepared to be capable of being physically handled within minutes of completion of the build process.

A plurality of layers of cured composition 46 may be accrued, one upon another, to form a solid three-dimensional object 52 (FIG. 6) having at least two regions 54, 56 which vary from one another in at least one material property. For instance, the solid three-dimensional object 52 may include a mechanically rigid core region 54 surrounded by a mechanically flexible outer region 56. Additionally, the methods of the present invention may be utilized to fabricate a plurality of three-dimensional objects in a single SFF build, at least one material property of at least one region of one object differing from the same material property of at least one region of another object fabricated during the same build. All such variations are contemplated to be within the scope of the present invention.

With respect to the choice of reactive build compositions 26, 28 and curing compositions 48, in a particular embodiment, the reactive build compositions 26, 28 and curing composition 48, where applicable, each may have a viscosity less than 70 centipoise at a temperature below about 200° C. It is currently more preferable that each of the reactive build compositions 26, 28, and the curing composition 48, where applicable, have a viscosity less than 20 centipoise at a temperature below about 100° C.

An exemplary reactive materials system comprises a first epoxy and a second epoxy as first and second reactive build compositions 26, 28 and a substance which reacts with the epoxy groups to open the epoxide ring structure(s) as a curing composition 48. Examples of functional groups that may be capable of reacting with epoxide ring structure(s) in this manner are amino groups, hydroxyl groups, and carboxyl groups. In one embodiment, each reactive build composition 26, 28 may be an epoxy and the curing composition 48 may include molecules containing at least two active hydrogens, such as diamines, which react with the epoxies to form a cured composition. In one embodiment, at least six or eight active hydrogens may be present. Bisphenol-containing epoxy resins may also be used as reactive build compositions 26, 28 with an amine as a curing composition 48. Some typical amine curing compositions that may be used include tetraethylene pentamine, triethylene tetramine, polyethylene polyamines, diethylene triamine, 2,2,4 trimethyl-1,6 hexanediamine, and aliphatic amines. Classes of curing compositions include, by way of example and not limitation, aliphatic amines, cycloaliphatic amines, aromatic amines, polyamines, oligoamines, polyimines, polyamides, amidoamines, dicyanamides, alcoholamines, anhydrides of carboxylic acids, carboxylic acids including dimmers and trimers, and polyfunctional alcohols. Some ethers can also be included with epoxy resins, such as n-butyl glycidyl ether, 1,4 butanediol diglycidyl ether, and alkyl glycidyl ether.

Further, some commercial products are available which may be utilized with the systems and methods of the present invention. For instance, epoxy resin DER 732 may be used as a first reactive build composition and epoxy resin DER 324 may be used as a second reactive build composition, the combination being utilized with an amine curing composition. Each of DER 732 and DER 324 is available from the Dow Chemical Company of Midland, Mich. DER 732 is a mechanically flexible epoxy resin and DER 324 is a mechanically rigid epoxy resin. These two resins may be dispensed in any ratio to fabricate a solid three-dimensional object having a range of mechanical properties from flexible to rigid. Exemplary amine curing agents include DEH 58 and DEH 29, both of which are also available from the Dow Chemical Company.

Other multi-part chemistries that are likely to offer similar flexibility in mechanical properties to the exemplary epoxy reactive materials systems include acylated urethanes, siloxanes, and norbornenes.

In an exemplary acrylated urethane materials system, the reactive build compositions 26, 28 may include polyisocyanates and the curing composition 48 may include a polyol for reacting with the polyisocyanates to form a cured composition of polyurethane. In other embodiments, the reactive build compositions 26, 28 may include isocyanate or polyisocyanate derivatives and the curing composition 48 may include one or more alcohols or polyols to form a cured composition.

In an exemplary silicone (siloxane) materials system, the reactive build compositions 26, 28 may include functionalized silicones, such as epoxy-functionalized silicones. The curing composition 48 may include compositions having moieties reactive with the functionalized silicones and may include one or more of the curing compositions described herein with respect to the epoxy reactive build compositions. Alternatively, a silicone-based curing composition 48 may also be used to react with NH and OH containing epoxies. Further, compositions having —Si-0- type backbones may be used and configured to have better mechanical flexibility than the compositions based on —C— bonds.

In an exemplary acrylate materials system, the reactive build compositions 26, 28 may include pre-polymers with unsaturated functionality and the curing composition 48 may include free-radical curing agents such as alkyl- or aryl-peroxides or hydroperoxides. Examples of pre-polymers that are functional include free-radical initiators including acrylates, multifunctional acrylates, urethane acrylates, epoxy acrylates, and silicon acrylates. Examples of curing compositions 48 may include peroxide initiators such as methyl ethyl ketone peroxide, benzoyl peroxide, acetylacetone peroxide, cumene hydroperoxide, and the like.

A solution of promoters such as aromatic amines and transition metal salts at lower oxidation states may be used to generate radicals in free-radical curing compositions 48. Examples of aromatic amines that may be used include dimethylaniline, diethylaniline, dimethylacetamide, and the like. Examples of transition metal salts that may be used include cobalt naphthenate or cobalt octoate. Amine promoters can also be used with cobalt promoters in conjunction with certain peroxide initiators like methyl ethyl ketone peroxide, particularly when rapid curing is desirable. This embodiment may form a cured composition by free-radical polymerization of unsaturated pre-polymers.

There are a few concepts to consider when using free-radical initiators. Particularly, free-radical initiators such as peroxides, and promoters such as amines and metal salts, should not be in the same phase before dispensing, as they would react immediately upon mixing. As such, in one embodiment, the promoters may be allocated in the reactive build compositions 26, 28 and the peroxide can be dispensed as a curing composition 48.

Additional reactive build compositions 26, 28 which may be utilized in the SFF systems of the present invention include, by way of example and not limitation, polyphosphazenes. Polyphosphazene and its derivatives, such as poly(aryloxy phosphazene), exhibit high chemical, mechanical, and thermo-oxidative stability. The backbone of polyphosphazene may be readily functionalized and grafted onto epoxy terminated silicone polymer. In another embodiment, poly(phosphazene) derivatized with anilinium groups may be polymerized to give a copolymer of aniline and phosphazene. This hybrid material includes the electronic conductivity of polyaniline and the mechanical/chemical stability and processability of polyphosphazene. The polymerization kinetics for aniline is rapid and, thus, a solid three-dimensional object utilizing poly(phosphazene) derivatized with anilinium groups may be fabricated in as little as a few minutes. To use this chemistry in the SFF systems and methods of the present invention, a solution or a dispersion of anilinium derivatized poly(phosphazene) may be reacted or mixed with a low pH ink that contains ammonium or potassium persulfate.

In place of aniline, organic molecules with large first hyperpolarizabilities such as 2-methyl-4-nitroaniline, and 4-dimethylamino-4′-nitro-stilbene (DANS) may be substituted onto the backbone of poly(phosphazene). This reaction yields a transparent and flexible nonlinear optical (NLO) material with potential applications, for instance, in display and optical switches.

The reactive build compositions 26, 28 and/or curing compositions 48 may also include a colorant in order to color the solid three-dimensional object. The colorant may include a dye(s) and/or a pigment(s). Colorants generally used include black, magenta, cyan, and yellow, but other colors may be used as well. Colorant may be added directly to a reactive build composition 26, 28 and/or curing composition 48 or may be added to a liquid vehicle containing a reactive build composition 26, 28 or curing composition 48. Each of the reactive build compositions 26, 28 and the curing compositions 48 may include no colorant, the same colorant, or different colorants, as desired.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention, as disclosed herein, which fall within the meaning and scope of the claims, are to be embraced thereby.

What is claimed is:

1. A method for freeform fabrication of a solid three-dimensional object, comprising:
providing a first reactive build composition having a material property defined by a first attribute;
providing a second reactive build composition having the material property defined by a second attribute, the first and second attributes differing from one another;
dispensing a first amount of the first reactive build composition and a second amount of the second reactive build composition onto at least a portion of a substrate to form a mixed composition; and
curing the mixed composition to form a layer of cured composition.

2. The method of claim 1, wherein curing the mixed composition to form a layer of cured composition comprises curing the mixed composition to form a layer of cured composition having the material property defined by a third attribute which differs from each of the first and second attributes.

3. The method of claim 1, further comprising accruing a plurality of layers of the cured composition successively bound to one another to form the solid three-dimensional object.

4. The method of claim 1, wherein dispensing a second amount of the second reactive build composition comprises dispensing a second amount of the second reactive build composition which varies within the layer of the cured composition.

5. The method of claim 3, wherein accruing a plurality of layers of the cured composition successively bound to one another comprises accruing a plurality of layers to form the solid three-dimensional object having at least a first region and a second region, and wherein dispensing a second amount of the second reactive build composition comprises dispensing a second amount of the second reactive build composition which differs between the first and second regions of the solid three-dimensional object.

6. The method of claim 1, wherein curing the mixed composition to form a layer of cured composition comprises exposing the mixed composition to a source of ultraviolet radiation.

7. The method of claim 1, wherein dispensing a first amount of the first reactive build composition and a second amount of the second reactive build composition onto at least a portion of a substrate to form a mixed composition further comprises dispensing a curing composition onto at least a portion of the substrate to form the mixed composition.

8. The method of claim 1, wherein dispensing a first amount of the first reactive build composition and a second amount of the second reactive build composition onto at least a portion of a substrate comprises dispensing the first reactive build composition from a first inkjet print cartridge and dispensing the second reactive build composition from a second inkjet print cartridge.

9. The method of claim 1, wherein dispensing a first amount of the first reactive build composition and a second amount of the second reactive build composition onto at least a portion of a substrate comprises dispensing the first and second reactive build compositions from a single inkjet print cartridge configured to separately contain the first and second reactive build compositions.

10. The method of claim 7, wherein dispensing a first amount of the first reactive build composition and a second amount of the second reactive build composition onto at least a portion of a substrate further comprises dispensing the first reactive build composition from a first inkjet print cartridge and the second reactive build composition from a second inkjet print cartridge, and wherein dispensing a curing composition onto at last a portion the substrate comprises dispensing the curing composition from a third inkjet print cartridge.

11. The method of claim 1, wherein dispensing a first amount of the first reactive build composition and a second amount of the second reactive build composition onto at least a portion of a substrate comprises dispensing the first and second reactive build compositions onto a build platform.

12. The method of claim 1, wherein dispensing a first amount of the first reactive build composition and a second amount of the second reactive build composition onto at least a portion of a substrate comprises dispensing the first and second reactive build compositions onto a previously formed layer of cured composition.

13. The method of claim 1, wherein dispensing a first amount of the first reactive build composition and a second amount of the second reactive build composition onto at least a portion of a substrate comprises dispensing the first reactive build composition under the second reactive build composition.

14. The method of claim 1, wherein dispensing a first amount of the first reactive build composition and a second amount of the second reactive build composition onto at least a portion of a substrate comprises dispensing the first reactive build composition over the second reactive build composition.

15. The method of claim 1, wherein dispensing a first amount of the first reactive build composition and a second amount of the second reactive build composition onto at least a portion of a substrate comprises interspersing the first and second reactive build compositions.

16. The method of claim 7, wherein dispensing a curing composition onto the substrate further comprises dispensing the curing composition over the first and second reactive build compositions.

17. The method of claim 7, wherein dispensing a curing composition onto at least a portion of the substrate further comprises interspersing the curing composition with at least one of the first and second reactive build compositions.

18. The method of claim 1, wherein providing a first reactive build composition and a second reactive build composition comprises providing first and second reactive build compositions each having a viscosity of less than 70 centipoise at a temperature below about 200° C.

19. The method of claim 7, further comprising adding a colorant to at least one of the first reactive build composition, the second reactive build composition, and the curing composition.

20. A system for freeform fabrication of a solid three-dimensional object, comprising:
a dispensing system configured to separately contain a first reactive build composition having a material property defined by a first attribute and a second reactive build composition having the material property defined by a second attribute, the first and second attributes differing from one another, and configured to independently dispense a first amount of the first reactive build composition and a second amount of the second reactive build composition onto at least a portion of a substrate to form a mixed composition; and
a curing system to cure the mixed composition and form a layer of cured composition.

21. The system of claim 20, wherein the dispensing system comprises at least one inkjet print cartridge for containing and dispensing the first and second reactive build compositions.

22. The system of claim 21, wherein the at least one inkjet print cartridge comprises a first compartment for containing the first reactive build composition and a second compartment for containing the second reactive build composition.

23. The system of claim 20, wherein the dispensing system comprises a first inkjet print cartridge for containing and dispensing the first reactive build composition and a second inkjet print cartridge for containing and dispensing the second reactive build composition.

24. The system of claim 20, wherein the first and second reactive build compositions have a viscosity of less than 20 centipoise at a temperature below about 200° C.

25. The system of claim 20, wherein the curing system comprises an ultraviolet curing system.

26. The system of claim 20, wherein the curing system comprises a chemical curing system.

27. The system of claim 20, wherein the dispensing system further comprises a first inkjet print cartridge for containing and dispensing the first reactive build composition, a second inkjet print cartridge for containing and dispensing the second reactive build composition, and a third inkjet print cartridge for containing and dispensing the curing composition.

28. The system of claim 20, wherein the dispensing system further comprises a first inkjet print cartridge having a first compartment for containing and dispensing the first reactive build composition and a second compartment for containing and dispensing the second reactive build composition, and a second inkjet print cartridge for containing and dispensing the curing composition.

29. The system of claim 20, wherein at least one of the first reactive build composition, the second reactive build composition, and the at least one curing composition includes a colorant.

30. A solid three-dimensional object formed by a freeform fabrication process, the solid three-dimensional object comprising a plurality of regions, each region comprising at least one layer of a cured composition, the at least one layer of the cured composition comprising a first amount of a first reactive build composition having a material property defined by a first attribute and a second amount of a second reactive build composition having the material property defined by a second attribute, wherein the material property of each region of the plurality of regions differs from the material property in another region of the plurality of regions.

31. The solid three-dimensional object of claim 30, wherein the mixed composition, after curing, has the material property defined by a third attribute which differs from each of the first and second attributes and is dependent upon the respective amounts of the first and second reactive build compositions.

32. The solid three-dimensional object of claim 30, wherein at least a portion of a first region of the plurality of regions and at least a portion of a second region of the plurality of regions are contained within a single layer of the cured composition.
